(19) United States
(12) Patent Application Publication
(10) Pub. No.: US 2022/0185016 A1
(43) Pub. Date: Jun. 16, 2022

(54) NON-PNEUMATIC TIRE

(71) Applicant: The Goodyear Tire & Rubber Company, Akron, OH (US)

(72) Inventors: Daniel Ray Downing, Uniontown, OH (US); Nate Edward Yensho, Akron, OH (US); Frank Anthony Kmiecik, Akron, OH (US); Michael Stefan Skurich, North Canton, OH (US); Steven Amos Edwards, Akron, OH (US); Arun Kumar Byatarayanapura Gopala, Copley, OH (US)

(21) Appl. No.: 17/452,662

(22) Filed: Oct. 28, 2021

Related U.S. Application Data
(60) Provisional application No. 63/126,201, filed on Dec. 16, 2020.

(51) Int. Cl. B60C 7/12; B60C 7/24; B60C 7/10

(52) U.S. Cl. CPC B60C 7/125; B60C 7/102; B60C 7/24

(57) ABSTRACT

A non-pneumatic tire and wheel assembly including a wheel having a first and second bead ring, a non-pneumatic tire having a shear band and tread forming a tread band, and a first and second sidewall region; wherein the first and second sidewall regions each extend from the tread band and terminate into a first and second respective bead area, wherein the first and second bead area are each mounted on the first and second bead ring, respectively; wherein each bead area is located axially outward of the crown region of the non-pneumatic tire when mounted on the wheel, and wherein the first and second sidewall each have an upper sidewall region that is uncoupled from the outer lateral ends of the tread band.

### FIELD OF THE INVENTION

The present invention relates generally to vehicle tires, and more particularly, to a non-pneumatic tire.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominant today. Pneumatic tires are efficient at carrying loads because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus, an improved non pneumatic tire that has all the features of the pneumatic tires without the drawback of the need for air inflation is desired.

### SUMMARY OF THE INVENTION

The invention provides in a first aspect a non-pneumatic tire and wheel assembly including a wheel having a first and second bead ring, a non-pneumatic tire having a shear band and tread forming a tread band, and a first and second sidewall region; wherein the first and second sidewall regions each extend from the tread band and terminate into a first and second respective bead area, wherein the first and second bead area are each mounted on the first and second bead ring, respectively; wherein each bead area is located axially outward of the crown region of the non-pneumatic tire when mounted on the wheel, and wherein the first and second sidewall each have an upper sidewall region that is uncoupled from the outer lateral ends of the tread band.

### BRIEF DESCRIPTION OF THE DRAWINGS

The present invention will be better understood through reference to the following description and the appended drawings, in which:

FIG. 1 is a cross-sectional view of a non-pneumatic tire of FIG. 1 mounted on a wheel rim;

FIG. 2 is a cross-sectional view of a second embodiment of a non-pneumatic tire;

FIG. 3 is a cross-sectional view of the non-pneumatic tire of FIG. 2 shown mounted on a wheel rim; and

FIG. 4 is a closeup cross-sectional view of one half of a pneumatic tire of the present invention.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inextensible” means a cord having a relative elongation at break of less than 0.2% at 10% of the breaking load, when measured from a cord extracted from a cured tire.

“Equatorial Plane” means a plane perpendicular to the axis of rotation of the tire passing through the centerline of the tire.

“Meridian Plane” means a plane parallel to the axis of rotation of the tire and extending radially outward from said axis.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### DETAILED DESCRIPTION OF THE INVENTION

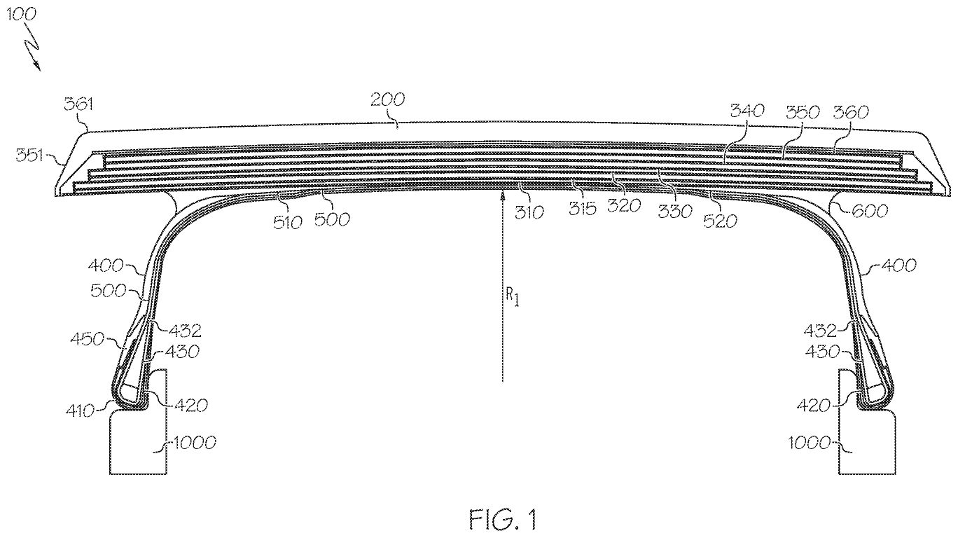

As shown in FIGS. 1-4, a non-pneumatic tire 100 of the present invention includes a radially outer ground engaging tread 200, which may be a conventional tread as desired, and may include elements such as ribs, blocks, lugs, grooves, and sipes as desired to improve the performance of the tire in various conditions.

In a first embodiment of a shear band 300, the shear band is comprised of at least two inextensible reinforcement layers 310,320 arranged in parallel, and separated by a shear matrix 315 of elastomer. Each reinforcement layer 310,320 may be formed of parallel reinforcement cords embedded in a thin elastomeric coating. The reinforcement cords are preferably inextensible, and may be made of steel, aramid, nylon, polyester, or other inextensible structure. In the first reinforced elastomer layer 310, the reinforcement cords are oriented at an angle in the range of 0 to about +/−50 degrees relative to the tire equatorial plane, and more preferably in the range of 0 to +/−10 degrees. In the second reinforced elastomer layer 320, the reinforcement cords are oriented at an angle in the range of 0 to about +/−50 degrees relative to the tire equatorial plane, more preferably 0 to +/−10 degrees. Preferably, the angle of reinforcement cords of the first layer is in the opposite direction of the angle of the reinforcement cords in the second layer. As shown, the shear band 300 may further optionally include as many additional reinforcement layers 330-360 to achieve the desired stiffness. It is additionally preferred that the radially outermost reinforcement layers 350,360 have outer lateral ends 351,361 having a reduced axial width as compared to the radially inner reinforcement layers 310-340.

The shear matrix layer 315 located between the first and second reinforcement layer 310,320 and is formed of an elastomer material having a shear modulus Gm in the range of 0.5 to 10 MPa, and more preferably in the range of 4 to 8 MPA. The thickness of the rubber layer 315 may have a radial thickness in the range of about 0.10 inches to about 0.2 inches, more preferably about 0.15 inches. If additional reinforcement layers 330-360 are utilized, the reinforcement layers may also be optionally separated by the shear layer 315. The belt package together with the shear layer form a shear band. The shear band together with the tread form an outer annular tread band.

As shown in FIG. 1, the non-pneumatic tire 100 of the present invention further includes two axially spaced apart sidewall portions 400 that extend inward from the tread to a wheel 50. The central portion of the tread band is in the range of 80-90% of the total axial width of the tread band, while the lateral ends are the remaining balance. The axially outer ends of the tread band are uncoupled from the carcass.

The radially innermost end 410 of each sidewall preferably includes an annular bead 420 which is secured to the wheel. The non-pneumatic tire 100 further includes a first layer of ply 500 which extends from the first bead 420 to the second bead 422. Preferably, the ply 500 comprises a reinforced rubber or ply layer formed of parallel reinforcement cords that are nylon, polyester, aramid or formed of a merged cord of nylon, polyester of aramid. Preferably, the reinforcements are oriented in the radial direction. The layer of ply extends radially inward from the tread, and is then wrapped around the first bead 420 and has a first end 510 that preferably terminates underneath the shear band 300 forming an envelope ply. A second end 520 of the ply likewise extends down from the tread, is wrapped around the opposite bead 420, and then terminates preferably underneath the shear band forming an envelope ply. Thus, each sidewall preferably has two effective layers of ply. Alternatively, the first and second ends 510,520 may wrap around the bead and terminate radially outward of a tip 432 of an apex 430.

Each apex 430 is preferably triangular in shape, and has a radial height as measured from the first end 431 to the tip 432. The radial height of the outer tip 432 is preferably in the range of ¼ to ¾ of the sidewall radial height, and more preferably in the range of ⅓ to ⅔ of the sidewall radial height. Each lower sidewall region which is defined as the lower half of the sidewall, is preferably stiffer relative to the stiffness of the upper half of the sidewall. The lower sidewall may be increased in stiffness by a stiff apex, or additional stiff material in the lower sidewall region such as a chafer or rim flange protector. The additional stiff material may be located on the axially outer portion of the lower sidewall, such as a rim flange protector or a chafer, or an axially inner portion such as a secondary apex.

The stiffness, which is the resistance to bending, may be characterized by the dynamic modulus G′, which are sometimes referred to as the “shear storage modulus” or “dynamic modulus,” reference may be made to Science and Technology of Rubber, second edition, 1994, Academic Press, San Diego, Calif., edited by James E. Mark et al, pages 249-254. The shear storage modulus (G′) values are indicative of rubber compound stiffness which can relate to tire performance. The tan delta value at 100° C. is considered as being indicative of hysteresis, or heat loss.

In a first embodiment, the first apex 430 comprises a stiff rubber composition having a shear storage modulus G′ measured at 1% strain and 100° C. according to ASTM D5289 ranging from 14 to 43 MPa. In a more preferred embodiment, the first apex 430 comprises a rubber composition having a shear storage modulus G′ measured at 1% strain and 100° C. according to ASTM D5289 ranging from 23 to 43 MPa.

The stiffened lower sidewall ensures that the ply is in tension after being mounted on the wheel, and also during use. When the ply and sidewall of the tire is in the relaxed state, the plyline is curved so that the beads are located axially inward of the shoulders of the tire. When the beads are loaded onto the rim, the curve is straightened and the bead or lower sidewall of the tire is moved axially outwards while still preferably remaining within the axial width of the tire shoulders, so that the ply acts as a spring.

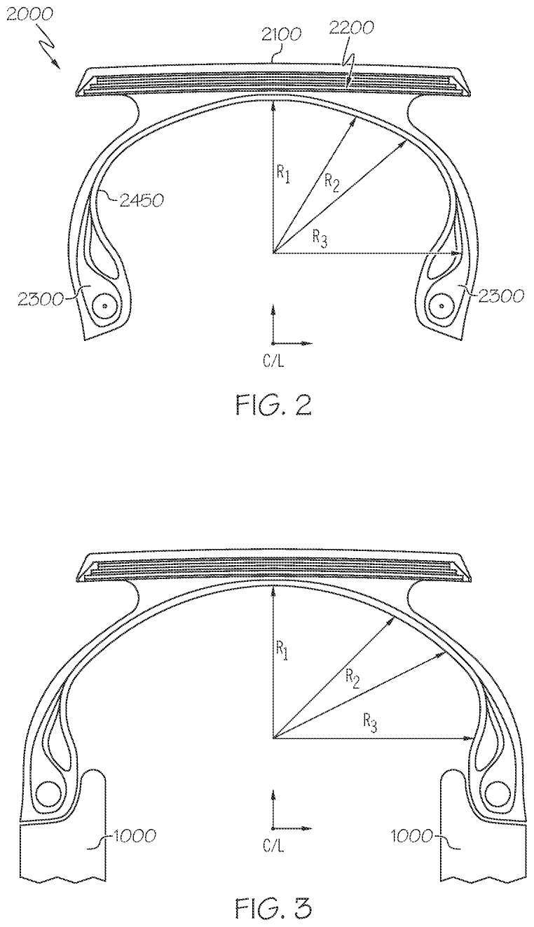

FIG. 2 illustrates a second embodiment 2000 of a non-pneumatic tire of the present invention mounted on the wheel. By design, the molded ply length is longer than the minimum distance between the molded beads and the shear band. In this design 2000, this is accomplished by making an increased radius R2 at the top 2450 of a second apex 2400. In this design, the radius under the tread R1 is much greater than the radius R2 at the top of the second apex. This design provides a mechanism for the cords to remain in tension as the shear band deforms into and out of the footprint. The second apex 2400 acts as a spring and provides the stiffness to tension the sidewalls. The shear band is loaded in so that it is compressed circumferentially. This combination of ply geometry will evenly load the shear band across its width, through a size dependent range of rim widths and vertical deflections. In a second embodiment, the first and/or second apex each comprise a stiff rubber composition having a shear storage modulus G′ measured at 1% strain and 100° C. according to ASTM D5289 ranging from 14 to 43 MPa, and more preferably ranging from 23 to 43 MPa.

FIG. 3 illustrates the tire mounted on the wheel with the ply tensioned in the sidewalls. The beads are seated into the L shaped recesses 900 as shown. In order to pretension the ply, the bead holders of the rim surface 1000 are displaced axially outward until the desired pretension is reached. The tension of the ply cords ensures that the tire is 100% of a top loader. In comparison to a run flat tire, wherein the stiffened sidewall members carry the load because the runflat tire functions as a bottom loader.

As shown in FIG. 3, the shearband layers remain horizontal after the tire sidewalls are pretensioned, because the geometry of the plyline is designed to distribute the compressive shear band loading evenly across the full width of the shear band. The deformed shape of the plyline is between the molded shape and a fully engaged shape. A fully engaged shape is defined as R1 and R3 being minimized to 0 (approaching linear discontinuity), and with R2 approaching infinity (Linear) FIG. 2. Maximum rim axial position will remain at or below this fully engaged ply geometry.

The stiffness of each sidewall, and more preferably, the lower half of the sidewall contributes to the top loading of the non-pneumatic tire. The lower half of each sidewall is preferably stiff, and may be stiffened due to a stiff apex, and/or a stiff mass of material located on the axially outer portion such as a chafer or rim flange protector. The sidewalls of the tire were pretensioned by axially expanding the wheel rim. In a third embodiment, a chafer or rim flange protector located axially outward of the apex comprises a stiff rubber composition having a shear storage modulus G′ measured at 1% strain and 100° C. according to ASTM D5289 ranges from 14 to 43 MPa, and more preferably from 23 to 43 MPa.

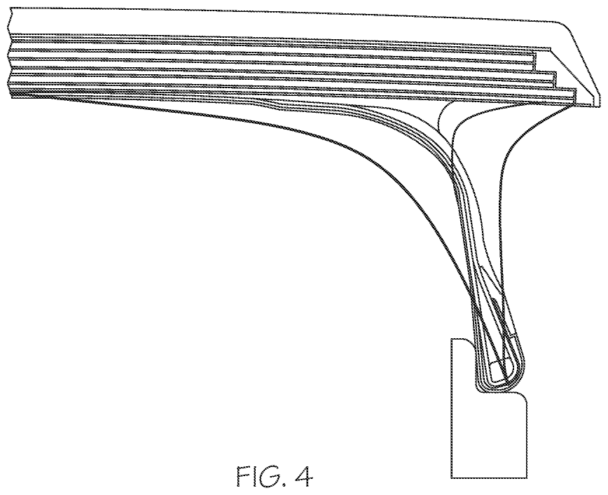

FIG. 4 illustrates an alternate embodiment showing an alternative ply line that has less curvature. The alternate embodiment may also have alternating molded holes in 3 dimensions for reducing weight. This would give the appearance of spokes.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A non-pneumatic tire and wheel assembly comprising:
a wheel having a first and second bead ring holder,
a non-pneumatic tire having a shear band and tread forming a tread band, and a first and second sidewall region;
wherein the first and second sidewall regions each extend from the tread band and terminate into a first and second respective bead area,
wherein a carcass ply extends under a crown portion of the non-pneumatic tire and into the first and second sidewall regions and has a first end secured to a first bead area and a second end secured to a second bead area,
wherein the first and second bead area are each mounted on the first and second bead ring holder; and
wherein the carcass ply is tensioned when each bead area is mounted on the respective bead holder of the wheel.

2. The non-pneumatic tire and rim assembly of claim 1 wherein the first and second sidewall each have an upper sidewall region that is not connected to an outer lateral end of the tread band.

3. The non-pneumatic tire and rim assembly of claim 1 wherein each bead is tensioned outward yet located axially inward of a respective shoulder of the non-pneumatic tire when mounted on the wheel.

4. The non-pneumatic tire and rim assembly of claim 1 wherein when the non-pneumatic tire is not mounted on the wheel and is in the unloaded condition, the carcass ply has a first radius R1 under a crown region of the tread, and a second radius R2 in the upper sidewall at the uncoupled location, and wherein R1 is greater than R2.

5. The non-pneumatic tire and rim assembly of claim 1 wherein the shear band is loaded in compression when the non-pneumatic tire is mounted on the wheel.

6. The non-pneumatic tire and rim assembly of claim 1 wherein the shear band is compressed circumferentially when the non-pneumatic tire is mounted on the wheel.

7. The non-pneumatic tire and rim assembly of claim 1 wherein the axial distance between the first and second bead rings are axially adjustable.

8. The non-pneumatic tire and rim assembly of claim 1 wherein each sidewall has at least two layers of reinforcement ply.

9. The non-pneumatic tire and rim assembly of claim 1 wherein the first end and the second end of the carcass ply are located in the crown portion of the tire.

10. The non-pneumatic tire and rim assembly of claim 1 wherein the sidewalls are angled at an angle α with respect to a horizontal surface of the rim.

11. The non-pneumatic tire and rim assembly of claim 1 wherein each bead area further includes an apex.

12. The non-pneumatic tire and rim assembly of claim 11 wherein the apex is formed of a stiff material having a shear storage modulus G′ measured at 1% strain and 100° C. according to ASTM D5289 ranging from 14 to 43 MPa.

13. The non-pneumatic tire and rim assembly of claim 1 wherein each bead area further includes a second apex, wherein the second apex is formed of a stiff material having a shear storage modulus G′ measured at 1% strain and 100° C. according to ASTM D5289 ranging from 14 to 43 MPa.

14. The non-pneumatic tire and rim assembly of claim 1 wherein the lower sidewall portion has a rib stiffener located axially outward of the apex, and wherein the rib stiffener is formed of a stiff material having a shear storage modulus G′ measured at 1% strain and 100° C. according to ASTM D5289 ranging from 14 to 43 MPa.

15. The non-pneumatic tire and rim assembly of claim 1 wherein the lower sidewall portion has a chafer, and wherein the chafer is formed of a stiff material having a shear storage modulus G′ measured at 1% strain and 100° C. according to ASTM D5289 ranging from 14 to 43 MPa.
